(19) United States
(12) Patent Application Publication
(10) Pub. No.: US 2011/0223095 A1
(43) Pub. Date: Sep. 15, 2011

(54) CARBON NANOTUBE FILM

(76) Inventors: Elizabeth Harvey, Dublin (IE); Jerome Joimel, Cambridge (GB); Anna Fenelon, Wexford (IE)

(21) Appl. No.: 13/119,939

(22) PCT Filed: Dec. 18, 2008
(86) PCT No.: PCT/US08/87494

§ 371 Date: Mar. 18, 2011

(51) Int. Cl. C01B 31/00; B29D 7/01; B05C 19/04; B82Y 30/00

(52) U.S. Cl. 423/448; 427/113; 118/308; 977/742

(57) ABSTRACT

An apparatus includes a substrate and a carbon nanotube film on the substrate. The carbon nanotube film includes microscopically visible overlapping dots of carbon nanotubes. The overlapping dots being microscopically visible signifies that the carbon nanotube film was formed by depositing a solution of the carbon nanotubes on the substrate in a single pass manner.

### BACKGROUND

Certain types of devices, such as display devices, employ at least partially transparent conductive films. Such films are both electrically conductive and optically transmissive. By comparison, most electrically conductive films, like copper and aluminum films, are not optically transmissive, and most optically transmissive films, like glass and plastic films, are not electrically films. A common example of such a transparent conductive film is an indium tin oxide film. However, indium tin oxide films are disadvantageous in that they are relatively brittle, and are susceptible to cracking when bent.

### BRIEF DESCRIPTION OF THE DRAWINGS

FIG. 1 is a flowchart of a method for forming a carbon nanotube film on a substrate, according to an embodiment of the present disclosure.

FIG. 2 is a diagram illustratively depicting drop spreading, according to an embodiment of the present disclosure.

FIG. 3 is a diagram illustratively depicting dot overlap, according to an embodiment of the present disclosure.

FIG. 4 is a diagram ideally depicting a carbon nanotube film formed on a substrate in a single pass manner, according to an embodiment of the present disclosure.

FIG. 5 is a flowchart of a method for preparing a solution of carbon nanotubes, according to an embodiment of the present disclosure.

FIG. 6 is a diagram illustratively depicting dispersion and debundling of carbon nanotubes in solution, according to an embodiment of the present disclosure.

FIG. 7 is a flowchart of a method for adjusting deposition parameters, according to an embodiment of the present disclosure.

FIG. 8 is a diagram illustratively depicting contact angles, according to an embodiment of the present disclosure.

FIG. 9 is a diagram illustratively depicting how deposition/ejection frequency and/or scanning head speed affects dot overlap, according to an embodiment of the present disclosure.

FIG. 10 is a diagram depicting the swaths of a substrate, according to an embodiment of the present disclosure.

FIG. 11 is a diagram depicting the underside of a scanning head, such as a scanning fluid-jet printhead, according to an embodiment of the disclosure.

FIG. 12 is a block diagram of a rudimentary fluid-jet device, according to an embodiment of the disclosure.

### DETAILED DESCRIPTION

### Problem, Solution, and Overview

As has been noted in the background section, at least partially transparent conductive films are both electrically conductive and optically transmissive, and a common example of such a transparent conductive film is made from indium tin oxide. However, because indium tin oxide films are relatively brittle, and are susceptible to cracking when bent, research has been performed to find transparent conductive film alternatives. One such alternative film is a carbon nanotube film.

Carbon nanotube films have been shown to be transparent conductive films that are significantly more flexible than conventional indium tin oxide films. However, current techniques for fabricating carbon nanotube films are disadvantageous. Such current techniques include vacuum filtration, spray deposition, photolithography and/or etching, and stamping. All of these techniques are disadvantageous because they waste significant amount of carbon nanotubes, which are relatively expensive, and because they require many relatively costly processing steps:

By comparison, fluid-jet printing techniques, such as inkjet-printing techniques, potentially could alleviate these concerns in fabricating carbon nanotube films. Fluid-jet printing techniques involve depositing a carbon nanotube solution in a precise manner on a substrate, so that a desired carbon nanotube film is formed on the substrate with minimal waste of carbon nanotubes, and with relatively few processing steps. However, current approaches using fluid-jet printing techniques to form carbon nanotube films have only been successful by requiring a significant number of passes over the substrate to achieve desired electrical and film optical properties.

A pass of a scanning fluid-jet printhead over a swath of a substrate is a single traversal of the printhead over the substrate swath, while the printhead is ejecting drops of the solution onto the swath. As noted above, current attempts to fabricate nanotube films using fluid-jet printing techniques have required many such passes—as few as ten passes in some instances, and as many as thirty passes in other instances. However, such multiple-pass fluid-jet printing carbon nanotube film-formation techniques are themselves undesirable.

First, having to employ multiple passes, which is also referred to as overprinting, is time consuming. This means that the relative throughput of the fabricating carbon nanotube films is reduced, increasing their ultimate cost. Second, the ejection of carbon nanotube solution drops has to be precisely aligned in each pass. Achieving such alignment is difficult at best, and also ultimately increases the end cost of the carbon nanotube films produced.

The inventors have novelly developed a process by which a carbon nanotube film is formed on a substrate using just a single pass. Single pass carbon nanotube film formation inherently solves the problems noted above and reduces fabrication cost. Throughput is increased, because just a single pass is needed to form the carbon nanotube film on the substrate. The problem of aligning the ejection of carbon nanotube solution drops between passes is sidestepped, because such alignment is not needed in a single pass process.

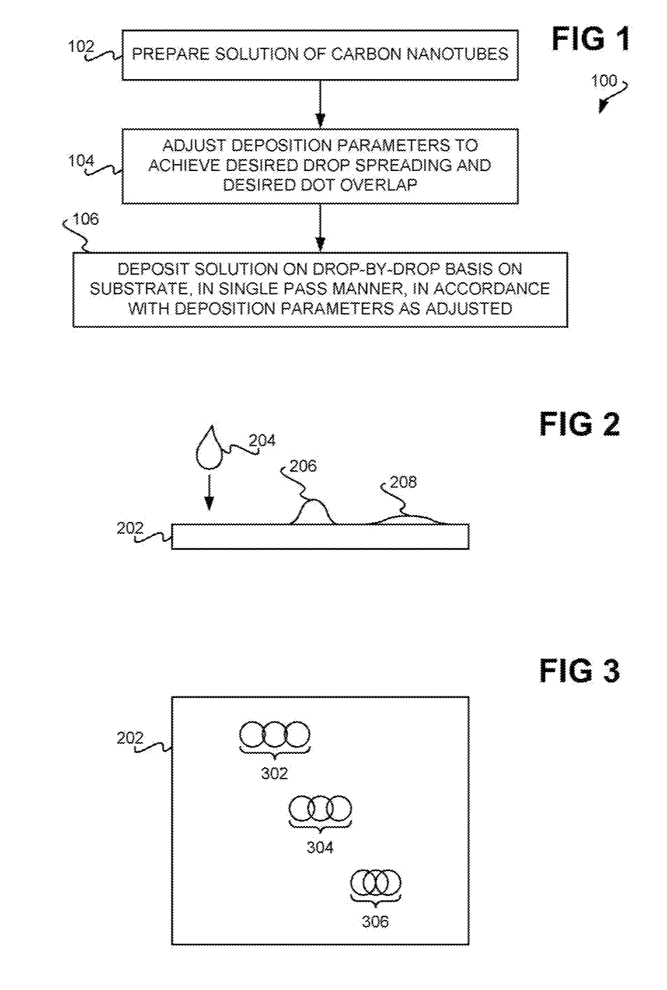

In this respect, then, FIG. 1 shows an inventive method 100 for forming a carbon nanotube film on a substrate in a single pass manner, according to an embodiment of the present disclosure. The method 100 is described in general terms in the remainder of this section of the detailed description. Thereafter, in subsequent sections of the detailed description, each part of the method 100 is discussed in more detail. It is noted that heretofore, forming a carbon nanotube film on a substrate in a single pass manner has not proven possible, such that the inventive contribution of the present disclosure is describing how such single-pass formation of carbon nanotube films can indeed be a reality.

A solution of carbon nanotubes is prepared (102). The solution is prepared so that the carbon nanotubes can be deposited on a drop-by-drop basis on a substrate. An example of such drop-by-drop deposition includes ejection of drops of the solution using an fluid-jet printing technique. The solution is also prepared based on a desired sheet resistance of the resultantly formed carbon nanotube film on the substrate, and based on a desired optical transmissivity of the carbon nanotube film.

It is noted that sheet resistance and optical transmissivity are competing objectives. Sheet resistance refers to the resistance of the carbon nanotube film per unit area, whereas optical transmissivity refers to how optically transmissive the carbon nanotube film is to light. In general, increased optical transmissivity results in increased sheet resistance, and decreased optical transmissivity results in decreased sheet resistance.

Ideally, sheet resistance is very low so that the carbon nanotube film is highly conductive, while optical transmissivity is very high so that the carbon nanotube film is very transparent. Because high sheet resistance results when optical transmissivity is low, and vice-versa, a compromise has to be made in how conductive the carbon nanotube film can be and how optically transparent the carbon nanotube film can be. For example, a typical carbon nanotube film may have an optical transmissivity of 90% and a sheet resistance of 10,000 ohms/square, although the exact values for a given film are dependent on the properties of the initial solution, primarily the type of carbon nanotubes used.

Deposition parameters are adjusted to achieve desired drop spreading of the carbon nanotube solution during deposition, as well as desired dot overlap of the carbon nanotubes as deposited on the substrate (104). The deposition parameters are further adjusted in accordance with the desired sheet resistance and the desired optical transmissivity of the carbon nanotube film. Drop spreading refers to the extent to which a solution drop spreads on the substrate after being deposited, whereas dot overlap refers to the extent to which the resultantly formed dots of carbon nanotubes on the substrate overlap each other, as is now described in more detail.

FIG. 2 shows different degrees of drop spreading in relation to a side view of a substrate 202, according to an embodiment of the present disclosure. For example purposes, a carbon nanotube solution drop 204 is shown as being ejected towards the substrate 202, where the drop 204 has not yet made contact with the substrate 202. The solution drop 204 includes carbon nanotubes as a solute dissolved in a solvent.

The carbon nanotube solution drop 206 that has contacted the substrate 202 has less drop spreading than the carbon nanotube solution drop 208 that has contacted the substrate 202. That is, the drop 208 has spread over the substrate 202 more than the drop 206 has. In general, the drop 206 covers less area of the substrate 202 than the drop 208 does, and projects higher from the substrate 202 than the drop 208.

FIG. 3 shows different degrees of dot overlap in relation to a top view of the substrate 202, according to an embodiment of the present disclosure. Carbon nanotube dots 302, 304, and 306 form on the substrate 202 after corresponding carbon nanotube solution drops have been ejected onto the substrate 202 and after the solvent has at least substantially evaporated away, leaving just the carbon nanotube solute. That is, the carbon nanotube dots 302, 304, and 306 are made up of primarily, if not only, the carbon nanotube solute that remains after the solvent of the solution drops has evaporated.

The carbon nanotube dots 302 exhibit a small degree of dot overlap, whereas the carbon nanotube dots 306 exhibit a large degree of dot overlap. The degree of dot overlap of the carbon nanotube dots 304 is between the degrees of dot overlap of the dots 302 and 306. At least some degree of dot overlap is desirable to ensure that that carbon nanotube film is conductive. If a series of carbon nanotube dots—such as the dots 302, the dots 304, or the dots 306—do not have any overlap, then there is more likely to be a break in the conductivity within the resulting carbon nanotube film.

In this respect, then, the deposition parameters are adjusted to achieve a desired drop spread and a desired dot overlap in part 104 of the method 100 of FIG. 1, in that the degree of drop spread affects the degree of dot overlap, and the degree of dot overlap provides a given margin of error in ensuring that the carbon nanotube film is conductive. Furthermore, the degree of drop spread and the degree of dot overlap affect the sheet resistance and the optical transmissivity of the resulting carbon nanotube film. The greater the drop spread and/or the greater the dot overlap is, the lesser the sheet resistance is and the lesser the optical transmissivity is. Likewise, lower drop spread and/or lower dot overlap increases sheet resistance and decreases optical transmissivity.

Referring back to FIG. 1, once the carbon nanotube solution has been prepared in part 102 and the deposition parameters adjusted in part 104, the solution is deposited on a drop-by-drop basis on the substrate in a single pass manner, in accordance with the deposition parameters as adjusted, to form the carbon nanotube film on the substrate (106). An exemplary process by which the carbon nanotube solution is ejected onto the substrate on a drop-by-drop basis uses fluid-jet printing techniques more commonly employed to form images on media using ink, where such fluid-jet techniques are specifically referred to as inkjet-printing techniques. However, other types of precision drop-by-drop ejection techniques may also be employed.

As noted above, depositing the carbon nanotube solution on a drop-by-drop basis in a single pass manner means that each part of the substrate is traversed by a scanning ejection head (e.g., a scanning fluid-jet printhead) just once while ejecting the solution. That is, a single pass manner of solution drop ejection precludes more than one pass being made over a given part of the substrate in which solution drops are being ejected onto the substrate. As such, it can be said that in effect the resultantly formed carbon nanotube film is a single layer film made up of carbon nanotube dots formed by ejecting carbon nanotube solution drops in a single pass. By comparison, a carbon nanotube film formed by ejecting carbon nanotube solution drops over multiple passes is a multiple layer film.

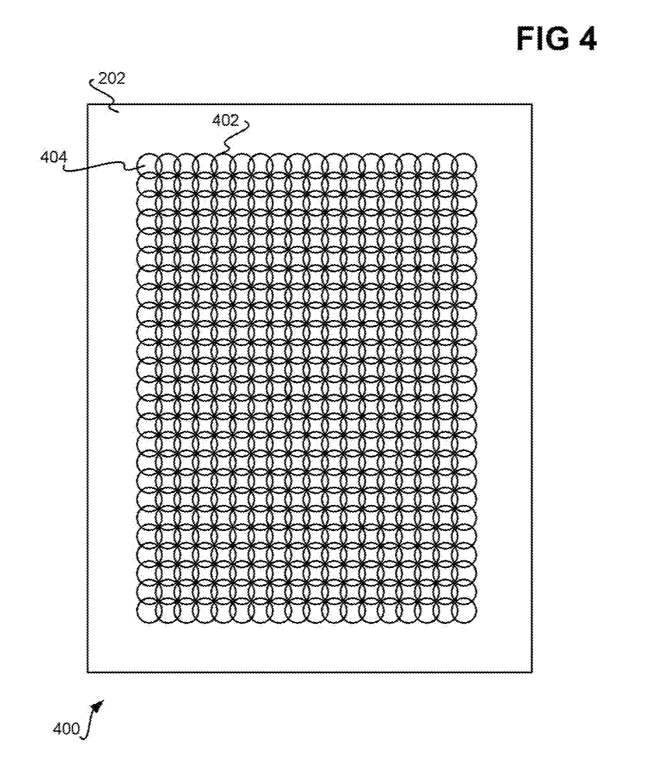

FIG. 4 shows an idealized top view of an apparatus 400 including the substrate 202 on which a carbon nanotube film 402 has been formed in accordance with the method 100, according to an embodiment of the disclosure. The carbon nanotube film 402 is made up of a number of carbon nanotube dots, such as the carbon nanotube dot 404 that is exemplarily called out in FIG. 4. The carbon nanotube dots overlap to some degree. It is noted that in actuality, the sizes of the carbon nanotube dots are very small, and may escape detection by the unaided human eye.

However, it has been found that overlapping dots of carbon nanotubes are microscopically visible when the carbon nanotube film 402 is formed by depositing a carbon nanotube solution on the substrate 202 in a single pass manner, such as by using a fluid-jet printing technique. Stated another way, the overlapping carbon nanotube dots being microscopically visible has been found to signify that the carbon nanotube film 402 was formed by depositing a carbon nanotube solution on the substrate 202 in a single pass manner. By comparison, for instance, a carbon nanotube film formed by depositing carbon nanotube solution droplets on a substrate in a multiple pass manner does not exhibit microscopically visible overlapping dots of carbon nanotubes.

As such, it can be determined whether a given carbon nanotube film has been formed on a substrate in a single pass manner or in a multiple pass manner by viewing the film under a microscope. If the film shows overlapping dots of carbon nanotubes, then it can be concluded that the film was formed in a single pass manner. By comparison, if the film does not show overlapping dots, then it may be able to be concluded that the film was not formed in a single pass manner, but rather was formed in a multiple pass manner. This difference may be because when multiple passes are employed, the resulting multiple layers of carbon nanotube dots obfuscates their identifiable overlapping nature, as is the case when a single pass is employed and that results in a single layer of dots.

It is finally noted that the apparatus 400 that includes the carbon nanotube film 402 formed on the substrate 202 can be any type of apparatus that employs transparent conductive films. A common example of such an apparatus is a display device. However, other types of apparatuses that may employ transparent conductive films include electronic devices and security printing applications.

### Preparation of Carbon Nanotube Solution

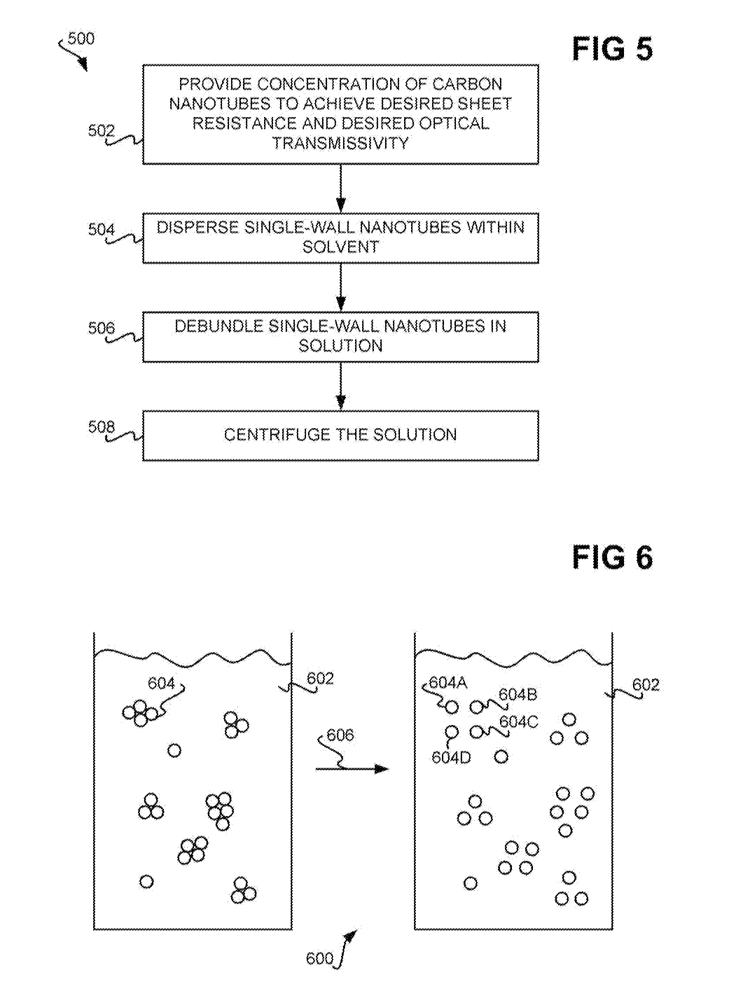

FIG. 5 shows a method 500 for preparing a carbon nanotube solution to implement part 102 of the method 100, according to an embodiment of the present disclosure. A concentration of carbon nanotubes is provided for within the solution that achieves the desired sheet resistance of the desired optical transmissivity of the resultantly formed carbon nanotube film (502). A higher concentration solution results in a higher density of carbon nanotubes in a given carbon nanotube dot, which itself results in a lower sheet resistance but lower optical transmissivity as well. Therefore, the carbon nanotube concentration in solution is selected to achieve the desired electrical-optical properties of a deposited carbon nanotube dot of the carbon nanotube film.

In one embodiment, single-wall nanotubes, as opposed to multiple-wall nanotubes, are dispersed within a solvent in the concentrated provided in part 502, such that the nanotubes become the solute of the resulting solution (504). For example 0.1%, by weight, of super-purified high-pressure carbon-monoxide conversion (HIPCO) single-wall nanotubes may be dispersed within deionized water containing 1% sodium dodecyl sulphate (SDS). Such single-wall nanotubes are available from Unidym, Inc., of Menlo Park, Calif.

A single-wall carbon nanotube is a single layered or walled tube of carbon, whereas a multiple-wall carbon nanotube, such as a double-wall carbon nanotube, is a multiple-layered or walled tube of carbon. Single-wall carbon nanotubes differ from multiple-wall carbon nanotubes in that they exhibit electric properties, such as conductivity, that are not shared by the multiple-walled carbon nanotubes. However, in general single-wall carbon nanotubes are more expensive to procure than multiple-wall carbon nanotubes.

It is noted that carbon nanotubes frequently form large bundles, which are undesirable because such bundling can hinder electronic transport and thus increase sheet resistance. Therefore, the single-wall nanotubes may be debundled within the solution (506). For instance, a sonication process may be employed for debundling purposes. To remove any remaining large bundles of nanotubes after debundling, the solution may be centrifuged (508), such as at 10,000 relative centrifugal force (RCF).

FIG. 6 illustratively depicts the dispersion and debundling/centrifuging of the method 500, according to an embodiment of the present disclosure. On the left-hand side of FIG. 6, carbon nanotube bundles, such as the carbon nanotube bundle 604, have been dispersed within a solvent 602, to become the solute of the solution 600. After debundling and centrifuging are performed, as denoted by the arrow 606, the resulting solution 600 on the right-hand side of FIG. 6 includes debundled carbon nanotubes within the solvent 602. For example, the carbon nanotube bundle 604 has been debundled into carbon nanotubes 604A, 604B, 604C, and 604D.

### Adjustment of Deposition Parameters

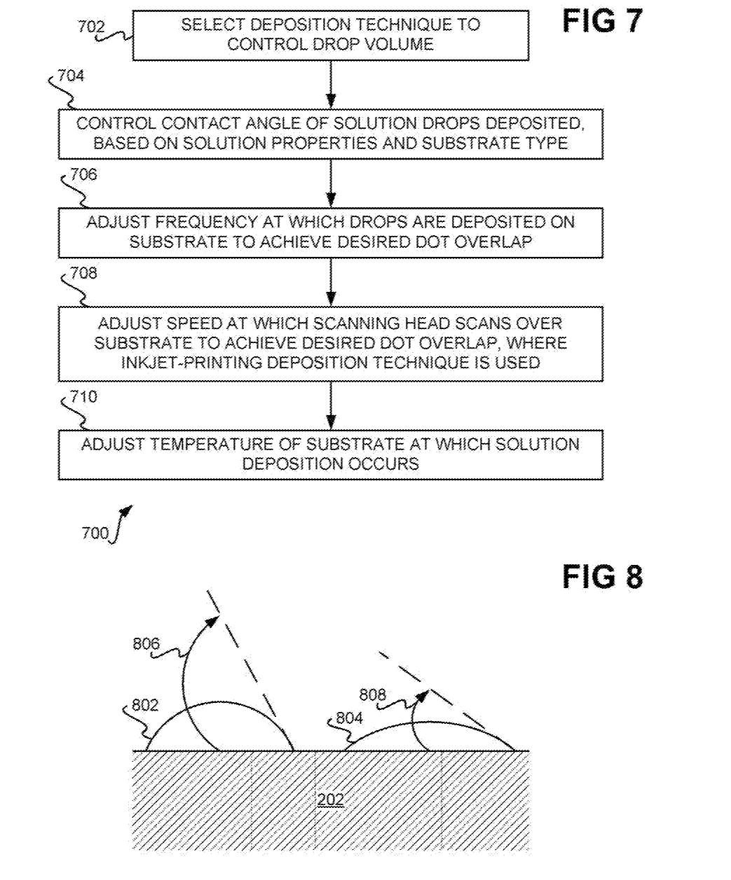

FIG. 7 shows a method 700 for adjusting deposition parameters to implement part 104 of the method 100, according to an embodiment of the present disclosure. A given deposition technique is selected to control the drop volume of carbon nanotube solution drops deposited on the substrate (702). The dot size of the carbon nanotube dots deposited on the substrate is itself controlled by this drop volume, as well as by the interaction between the solution and the type of the substrate in question.

For instance, a fluid-jet printing deposition technique may be selected in part 702. However, different fluid-jet printheads eject drops of different volumes, such that an appropriate fluid-jet printhead is selected to achieve a desired drop volume based on the dot size desired. As has been noted above, drop spreading also is used to control dot size. Greater drop spreading results in a thinner, larger-in-area carbon nanotube dot, which results in increased optical transmissivity but increased sheet resistance as well. A larger drop volume can result in more drop spreading for a given type of substrate.

However, the type of substrate also affects dot size, by impeding or promoting drop spreading. For instance, a polyethylene terepthalate (PET) substrate interacts with a carbon nanotube solution drop to result in more drop spreading, and thus a larger dot size than does a polyethylene naphthalate (PEN) substrate. Therefore, for a given type of substrate that is used and for a given solution of carbon nanotubes, a deposition technique is selected in part 702 that will result in a drop volume that will yield the desired dot size of carbon nanotube dots being formed on the substrate.

The contact angle of the carbon nanotube solution drops deposited can also be controlled, based on the properties of the solution and the substrate type (704). The contact angle is the angle at which the solution drops meet the substrate. Greater drop spreading results in lower contact angles, whereas lesser drop spreading results in higher contact angles. In this respect, controlling the contact angle as a deposition parameter to be adjusted can be considered as complementary to selecting the deposition technique as a deposition parameter to be adjusted (i.e., controlling drop volume as a deposition parameter to be adjusted).

For instance, the contact angle can be adjusted by processing of the substrate. As one example, processing the substrate within oxygen plasma changes the surface energy of the substrate. Such a treatment has been shown to result in a reduction in contact angle between the carbon nanotube solution and a PET substrate from about 43-47 degrees to about 15-18 degrees.

FIG. 8 illustratively depicts the concept of contact angle, according to an embodiment of the present disclosure. The solution drop 802 has spread over the substrate 202 less than the solution drop 804 has spread. As a result, the contact angle 806 between the drop 802 and the substrate 202 is greater than the contact angle 808 between the drop 804 and the substrate 202.

Referring back to FIG. 7, the frequency at which carbon nanotube solution drops are to be deposited on the substrate is controlled to achieve a desired dot overlap (706). Likewise, the speed at which a scanning head, such as a fluid-jet printhead where fluid-jet printing is used as the deposition technique, is also adjusted to achieve the desired dot overlap (708). In general, for a given amount of dot spreading, the higher the frequency of drop deposition/ejection, the greater the dot overlap that results, and similarly, for a given amount of dot spreading, the lower the frequency of drop deposition/ejection, the lesser the dot overlap that results. Furthermore, in general, for a given amount of dot spreading, the lower the velocity of the scanning head, the greater the dot overlap that results, and similarly, for a given amount of dot spreading, the higher the velocity of the scanning head, the lesser the dot overlap that results.

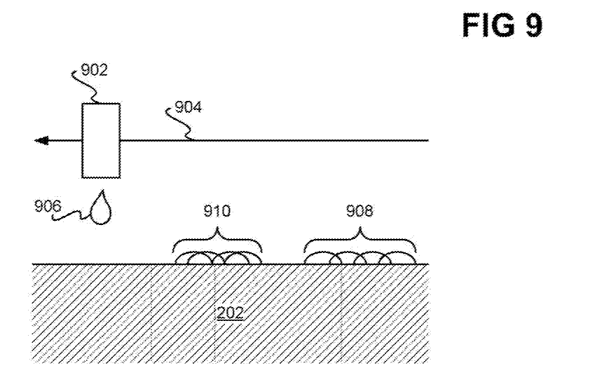

FIG. 9 illustratively depicts how deposition frequency and/or head speed can affect dot overlap, according to an embodiment of the present disclosure. A scanning head 902 moves, or scans, from right to left over the substrate 202, ejecting carbon nanotube solution drops, such as the drop 906, as it does so. The scanning head 902 is employed when using a scanning deposition technique, such as a scanning fluid-jet printing deposition technique, in which case the head 902 is a scanning fluid-jet printhead.

When the scanning head 902 deposits the carbon nanotube solution drops that result in the carbon nanotube dots 908, it is moving at a faster speed and/or is ejecting the solution drops at a lower frequency than when the head 902 deposits the solution drops that result in the carbon nanotube dots 910. This is because the carbon nanotube dots 908 have less overlap than the carbon nanotube dots 910 have. Thus, for a given scanning speed of the scanning head 902, the dots 908 are ejected or deposited at a lower frequency than the dots 910 are. Alternatively, for a given ejection or deposition frequency, the scanning head 902 is moving at a faster speed when forming the dots 908 as compared to when forming the dots 910.

It is noted that a scanning head typically is able to eject a number of rows of drops at a given time while it traverses the substrate. The height of these rows in total is referred to as the swath height, in the y-direction, and corresponds to a swath of the substrate on which drops can be ejected at any one time while moving in the x-direction. If the ejection nozzles of a scanning head are organized over two or more staggered columns, then the amount of overlap between adjacent nozzles in adjacent columns—in addition to dot spreading—affects the amount of overlap between adjacent dots in the y-direction. Such a staggered formation of ejection nozzles is described in more detail later in the detailed description. (By comparison, the amount of dot overlap in the x-direction is controlled by speed and frequency, as, has been described in relation to FIG. 9, as well as by dot spreading). By comparison, if the nozzles are organized such that there is no overlap of nozzles in adjacent columns, or if there is just one column of nozzles, then the dot overlap is determined by the dot diameter (i.e., the dot size). (However, from swath to swath of the substrate, dot overlap may be controlled by how much the head is relatively moved in the y-direction in relation to the substrate.) If only one nozzle is used, the dot overlap in the y direction is controlled by the dot size and the distance that the head is moved in the y direction in relation to the substrate.

Referring back to FIG. 7, the temperature of the substrate while the solution drops are deposited on the substrate may also be adjusted as a deposition parameter (710). For instance, the higher the temperature of the substrate, the greater the degree of drop spreading that occurs, and the lower the temperature of the substrate, the lesser the degree of drop spreading that occurs. In this sense, the temperature of the substrate can also be said to affect the dot size by optimizing the solution volume deposited per unit of the substrate. This is because the greater the degree of drop spreading that occurs, the lower the solution volume deposited per unit of substrate, and the lesser the degree of drop spreading that occurs, the higher the solution volume deposited per unit of substrate. This relationship is easily seen by comparing the less spread drop 206 of FIG. 2 to the more spread drop 208 of FIG. 2. Thus, adjusting the drop volume ejected, and/or the temperature of the substrate, and/or the frequency at which carbon nanotube solution drops are deposited, and/or the speed at which a scanning head scans over the substrate during such deposition, controls the volume of solution deposited per unit area of the substrate.

It is noted that there can be an upper limit on the volume of carbon nanotube solution per unit area of the substrate. That is, if this volume per unit area is too large, then the solution may bead on the substrate, resulting in puddling of the solution on the substrate. This puddling effect is desirably avoided, as it can prevent the carbon nanotube dots from properly forming on the substrate and consequently lead to a loss of control over the film properties.

### Deposition of Carbon Nanotube Solution

As noted above, once the solution of carbon nanotubes has been prepared in part 102 of the method 100 of FIG. 1, and after the deposition parameters have been adjusted in part 104 of the method 100, the prepared solution is deposited on a drop-by-drop basis on the substrate in a single-pass manner in accordance with the adjusted deposition parameters to form the carbon nanotube film on the substrate. An exemplary single-pass deposition technique that has been referenced herein is a single-pass scanning fluid-jet printing technique. In this technique, a fluid-jet printhead ejects carbon nanotube solution drops in a single pass over each swath of the substrate. This technique is now described in more detail.

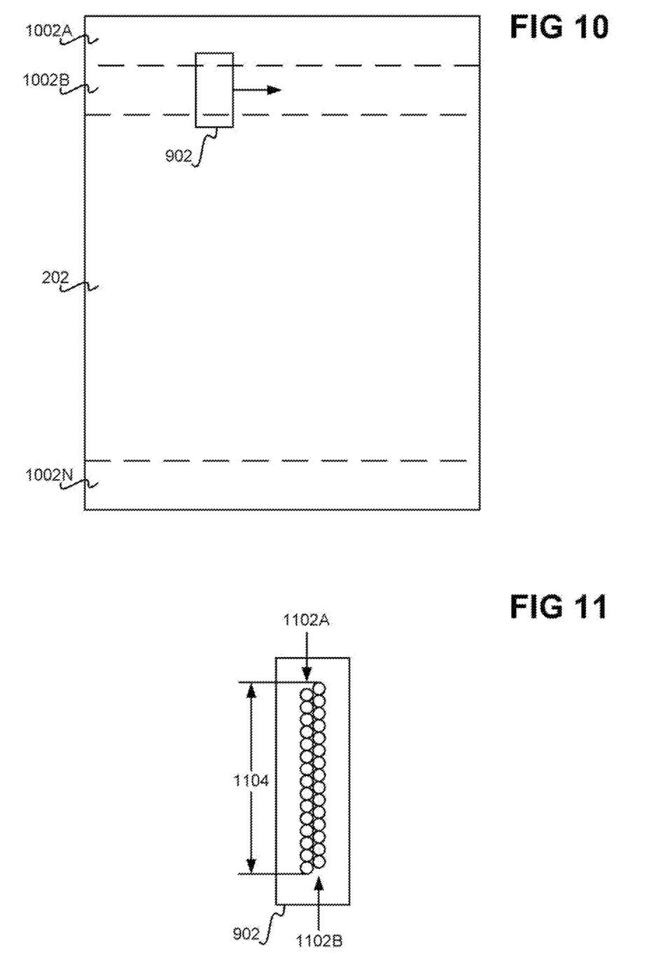

FIG. 10 shows how the substrate 202 is logically divided into a number of swaths 1002A, 1002B, . . . , 1002N, collectively referred to as the swaths 1002, according to an embodiment of the present disclosure. The scanning head 902 scans over each of the swaths 1002 once while depositing or ejecting carbon nanotube solution drops over the swath. In this way, the scanning deposition technique is a single pass technique, and is a fluid-jet printing technique where the scanning head 902 is a scanning fluid-jet printhead.

For instance, the scanning head 902 may scan, or move, from right to left over the swath 1002A, and eject carbon nanotube solution drops over the swath 1002A as it so scans or moves. Thereafter, the scanning head 902 is moved down relative to the substrate 202 by one swath so that the head 902 becomes incident to the swath 1002B, as is particularly depicted in FIG. 10. The scanning head 902 may then scan from left to right over the swath 1002B, and eject carbon nanotube solution drops over the swath 1002B as it scans or moves. This process is repeated until all the swaths 1002 of the substrate 202 have been traversed by the scanning head 902 exactly once while the head 902 is ejecting carbon nanotube solution drops.

FIG. 11 shows the underside of the scanning head 902 in exemplary detail, according to an embodiment of the present disclosure. The fluid-ejection nozzles of the scanning head 902 are organized over two staggered columns 1102A and 1102B in FIG. 11, which are collectively referred to as the columns 1102. Of course, there may be more or less than two columns 1102, and the columns may not be staggered relative to one another. The height of each of the swaths 1002 in FIG. 10 is indicated by the height 1104 of the ejection nozzles in FIG. 11.

However, having at least two columns 1102 that are staggered is advantageous. This is because, as has been noted above, staggered columns of nozzles permit carbon nanotube dot overlap in the y-direction (i.e., along the height of each of the swaths as represented by the height 1104) due to this staggering. By comparison, if there is just one column of nozzles, or if there are multiple columns nozzles that are not staggered relative to one another, then dot overlap cannot be achieved by nozzle column staggering—since there is no nozzle overlap in the y-direction in such instance—but rather just by drop spreading. Alternatively, a single nozzle can be utilized. In this case, the dot overlap is controlled in the y-direction by the dot diameter and the swath movement in the y direction.

Single pass carbon nanotube solution deposition to form a carbon nanotube film on a substrate as has been described herein is thus advantageous. First, because carbon nanotubes can be precisely deposited in the desired pattern of the carbon nanotube film, no carbon nanotubes are wasted in the formation of the film. Second, because such deposition is achieved in a single pass, the time it takes to form a carbon nanotube film is reduced as compared to multiple pass techniques. For these reasons, as well as other reasons, the embodiments of the present disclosure as have been described herein provide for advantages over the prior art.

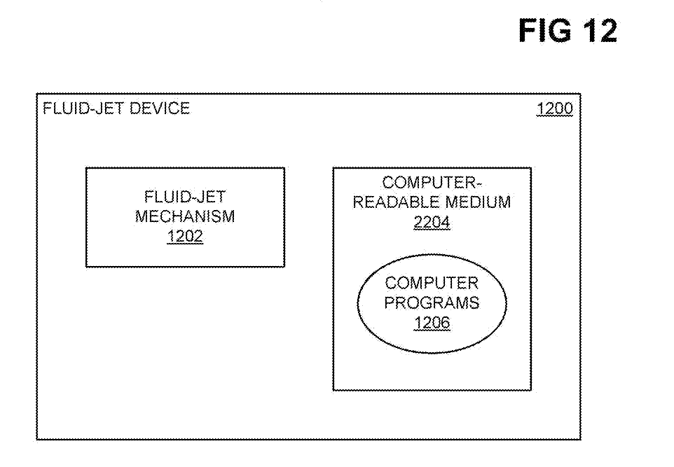

In conclusion, FIG. 12 shows a rudimentary fluid-jet device 1200, according to an embodiment of the disclosure. The fluid-jet device 1200 includes a fluid-jet mechanism 1202, a computer-readable medium 1204, and/or one or more processors 1208. The fluid-jet mechanism may be a scanning fluid-jet head, such as the scanning head 902 that has been described. The computer-readable medium 1204 may be or include a tangible computer-readable medium, such as semiconductor memory, a magnetic storage device like a hard disk drive, an optical storage medium such as an optical disc, and/or another type of computer-readable medium. The computer-readable medium 1204 stores one or more computer programs 1206. The processors 1208 are communicatively connected to the computer-readable medium 1204, and execute the computer programs 1206 stored on the medium 1204.

The fluid-jet mechanism 1202 is able to eject carbon nanotube solution drops on a substrate in a single-pass manner to form a carbon nanotube film on the substrate, as has been described in detail herein. The computer programs 1206 thus control the fluid-ejection mechanism 1202 to cause the fluid-jet mechanism 1202 to eject the carbon nanotube solution drops on the substrate in the single-pass manner to form the carbon nanotube film on the substrate. The computer programs 1206 specifically control the fluid-ejection mechanism 1202 such that the carbon nanotube film comprises a plurality of microscopically visible overlapping dots of carbon nanotubes, as has also been described herein.

We claim:

1. An apparatus comprising:
a substrate; and,
a carbon nanotube film on the substrate, the carbon nanotube film comprises a plurality of microscopically visible overlapping dots of carbon nanotubes,
wherein the overlapping dots being microscopically visible signifies that the carbon nanotube film was formed by depositing a solution of the carbon nanotubes on the substrate in a single pass manner.

2. A method for forming a carbon nanotube film on a substrate, comprising:
preparing a solution of carbon nanotubes, the solution prepared so that the carbon nanotubes can be deposited on a drop-by-drop basis, the solution also prepared based on a desired sheet resistance of the carbon nanotube film and based on a desired optical transmissivity of the carbon nanotube film;
adjusting deposition parameters to achieve a desired drop spreading of the solution during deposition and a desired dot overlap of the carbon nanotubes as deposited on the substrate, in accordance with the desired sheet resistance of the carbon nanotube film and in accordance with the desired optical transmissivity of the carbon nanotube film; and,
in a single pass manner, depositing the solution on the drop-by-drop basis on the substrate in accordance with the deposition parameters as adjusted, to form the carbon nanotube film on the substrate.

3. The method of claim 2, wherein preparing the solution of carbon nanotubes so that the carbon nanotubes can be deposited on the drop-by-drop basis comprises:
dispersing single-wall nanotubes within a solvent; and,
debundling the single-wall nanotubes as dispersed within the solvent to at least substantially free the solution of large bundles of carbon nanotubes.

4. The method of claim 3, wherein preparing the solution of carbon nanotubes so that the carbon nanotubes can be deposited on the drop-by-drop basis further comprises, after debundling the single-wall nanotubes, centrifuging the solution to remove any remaining large bundles of carbon nanotubes from the solution.

5. The method of claim 3, wherein dispersing the single-wall nanotubes within the solvent comprises dispersing the single-wall nanotubes within deionized water having a percentage of sodium dodecyl sulphate.

6. The method of claim 3, wherein debundling the single-wall nanotubes comprises debundling the single-wall nanotubes by sonication.

7. The method of claim 2, wherein preparing the solution of carbon nanotubes based on the desired sheet resistance of the carbon nanotube film and based on the desired optical transmissivity of the carbon nanotube film comprises providing a concentration of the carbon nanotubes within the solution to achieve the desired sheet resistance and the desired optical transmissivity of the carbon nanotube film.

8. The method of claim 2, wherein adjusting the deposition parameters comprises selecting a deposition technique to control a drop volume of drops of the solution deposited on the substrate, where a size of dots of the carbon nanotubes deposited on the substrate is controlled by the drop volume of the drops and by interaction between the solution and a type of the substrate.

9. The method of claim 2, wherein adjusting the deposition parameters comprises controlling a contact angle of the drops of the solution deposited on the substrate based on properties of the solution and a type of the substrate.

10. The method of claim 2, wherein adjusting the deposition parameters comprises adjusting at least a frequency at which drops of the solution are deposited on the substrate to achieve the desired dot overlap of the carbon nanotubes as deposited on the substrate,
where a higher frequency increases dot overlap and a lower frequency decreases the dot overlap.

11. The method of claim 10, wherein adjusting the deposition parameters further comprises adjusting a speed at which a scanning head scans over the substrate to achieve the desired dot overlap of the carbon nanotubes as deposited on the substrate,
where a higher velocity decreases the dot overlap and a lower velocity increases the dot overlap.

12. The method of claim 2, wherein adjusting the deposition parameters further comprises adjusting a temperature of the substrate at which deposition of the solution on the substrate occurs to affect a size of dots of the carbon nanotubes deposited on the substrate by optimizing a volume of solution deposited per unit area of the substrate.

13. The method of claim 12, wherein adjusting the deposition parameters further comprises adjusting one or more of (a) a frequency at which drops of the solution are deposited on the substrate, and where a deposition technique used to deposit the solution on the drop-by-drop basis is a scanning fluid-jet printing technique, (b) a speed at which a fluid-jet printhead scans over the substrate,
to affect the size of the dots of the carbon nanotubes deposited on the substrate by optimizing the volume of solution deposited per unit area of the substrate.

14. The method of claim 2, wherein depositing the solution on the drop-by-drop basis on the substrate comprises ejecting the solution on the drop-by-drop basis using a fluid-jet printhead.

15. A fluid-jet device comprising:
a fluid-jet mechanism to eject carbon nanotube solution drops on a substrate in a single-pass manner to form a carbon nanotube film on the substrate; and,
a computer-readable medium having one or more computer programs stored thereon to cause the fluid-jet mechanism to eject the carbon nanotube solution drops on the substrate in the single-pass manner to form the carbon nanotube film on the substrate such that the carbon nanotube film comprises a plurality of microscopically visible overlapping dots of carbon nanotubes,
wherein the overlapping dots being microscopically visible signifies that the carbon nanotube film was formed by depositing a solution of the carbon nanotubes on the substrate in a single pass manner.
